(19) United States
(12) Patent Application Publication
(10) Pub. No.: US 2013/0262337 A1
(43) Pub. Date: Oct. 3, 2013

(54) METHOD AND SYSTEM FOR AUTOMATIC REPORT SENDING

(71) Applicant: Boaz HAREL, Tel Aviv (IL)

(72) Inventor: Boaz HAREL, Tel Aviv (IL)

(21) Appl. No.: 13/433,432

(22) Filed: Mar. 29, 2012

(51) Int. Cl. G06Q 10/08

(52) U.S. Cl. 705/341

(57) ABSTRACT

Embodiments of the present invention are directed to an automatic report system and method and may include storing parameters related to the report in a memory of a data logger, collecting during shipment transit, data related to a content of the shipment, generating a report based on the parameters upon arrival of the shipment to a destination and automatically sending the report to a contact person.

### FIELD OF THE INVENTION

The present invention relates to the field automatic report sending.

### BACKGROUND

One of the critical issues in long-haul goods transportation is ensuring the integrity of the goods during transit and upon arrival at the final destination. Operators may overcome this problem by including data loggers in the goods containers during shipment, to measure for example the temperature or other relevant parameters during the entire delivery cycle. However, operators must also ensure that the goods have not been exposed to conditions exceeding acceptable levels during shipment. This information must be provided as soon as the shipment has arrived to its final destination so that conclusions regarding product quality may be reached.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a pictorial illustration of data logging and monitoring flow in accordance with embodiments of the present invention; and

FIG. 2 is a flowchart of a method for automatic report sending according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However it will be understood by those of ordinary skill in the art that the embodiments of present invention may be practiced without these specific details. In other instances, well-known methods, procedures and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification and claims to describe two or more components, devices, elements, units, parameters, or the like. For example, “a plurality of devices” may include two or more devices.

Some embodiments of the invention may be implemented, for example, using an article including or being a non-transitory machine-readable or computer-readable storage medium, having stored thereon instructions, that when executed on a computer, cause the computer to perform method and/or operations in accordance with embodiments of the invention. The computer-readable storage medium may store an instruction or a set of instructions that, when executed by a machine (for example, by a computer, a mobile device and/or by other suitable machines), cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Video Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Embodiments of the present invention are directed to an automatic report system in applications which include for example data loggers or other data recording devices used to monitor data regarding or describing the contents of a shipment such as ambient conditions during, for example, goods transportation. The automatic report may be required in order to verify the integrity of the shipment and may be generated at any stage during the shipment when the data logger is connected to a computer.

Data loggers or other data recording devices are a vital tool for monitoring and recording a variety of data. An exemplary data logger is sold under the trade name of MicroLite Universal Serial Bus (USB) data logger by Fourtec—Fourier Technologies Ltd, Rosh Ha'ayin, Israel, the assignee of this patent application. Such a data logger may offer a “plug and record data” solution for a plurality of applications, for example, industrial environments, such as food, pharmaceutical, medical, storage and transportation industries. An example for a use of such a data logger is monitoring the temperature during long-haul transports of food. Such a logger may include high accuracy sensors able to sense or detect one or more parameters such as, temperature, humidity, light and the like.

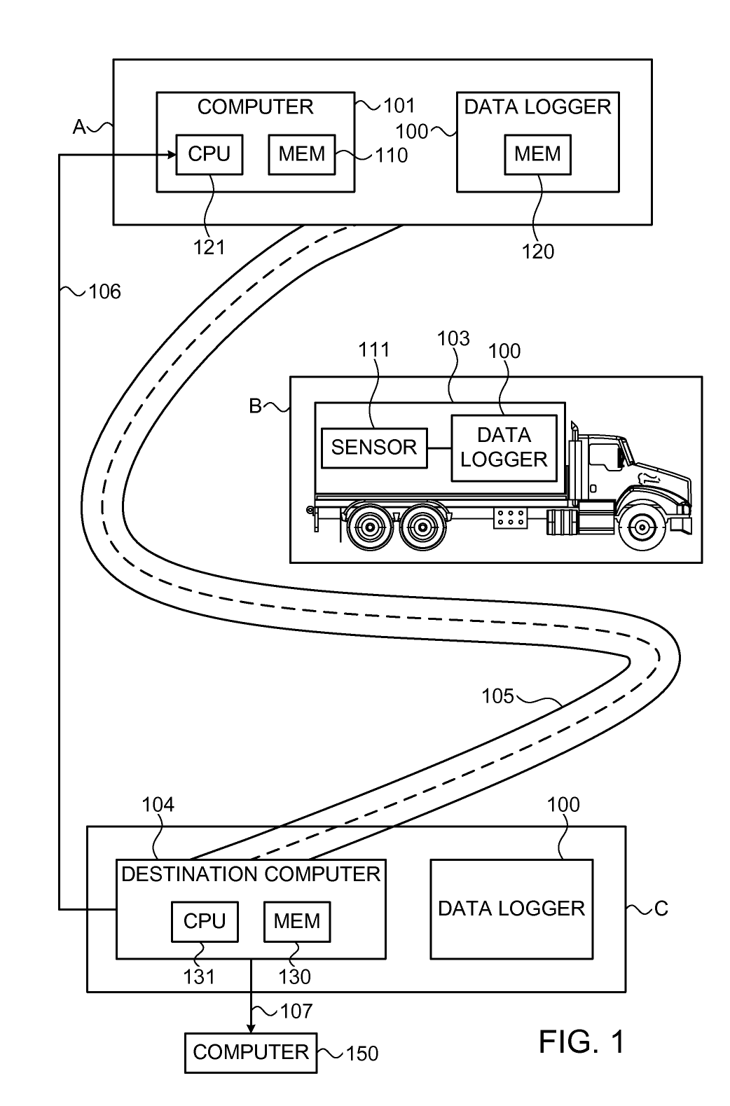

Reference is now made to FIG. 1, which is a pictorial illustration of data logging and monitoring flow in accordance with embodiments of the present invention. Elements A, B and C in this respective order, illustrate a chronological continuity of events throughout a process of temperature monitoring during long-haul transportation of goods such as food. Data other than temperature may be saved and stored. Element “A” represents a shipment departure site which may include an origin computer 101 and a data logger 100. While in one embodiment a data logger is described, in other embodiments, unit 100 may be any suitable data or parameter recording device. Origin computer 101 may be any computing device which may include or may be, for example, a personal computer, a desktop computer, a mobile computer, a laptop computer, a notebook computer, a terminal, a workstation, a server computer, a Personal Digital Assistant (PDA) device, a tablet computer, a network device, a mobile phone, a household appliance or any other suitable computing device. Any other device or component having a processing unit may be used. According to embodiments of the present invention, computer 101 may include components such as, but not limited to, one or more central processing units (CPU) 121 or any other suitable multi-purpose or specific processors or controllers, a plurality of input units, a plurality of output units, a plurality of memory units, and a plurality of storage units. Computer 101 may additionally include other suitable hardware components and/or software components.

Computer 101 and/or CPU 121 may include or execute instructions in conjunction with one or more operating systems which may be or may include any code segment designed and/or configured to perform tasks involving coordination, scheduling, arbitration, supervising, controlling or otherwise managing operation of computer 101, for example, scheduling execution of programs. Computer 101 may include or be associated with a memory 110 which may store data operated on or created by embodiments of the present invention such as, for example, setup parameters for a logging process.

Data logger 100 may include a memory 120 and may be any portable data logging device. Data logger 100 may be used for data logging and monitoring of, for example, controlled industrial environments, such as food, pharmaceutical, medical, storage and transportation industries. Using data logger 100 may allow delivering high quality products, ensuring consumer safety, complying with regulatory requirements and increasing profitability as described in embodiments of the invention.

Memory 110 of computer 101 and/or memory 120 of data logger 100 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 110 and memory 120 may be or may include a plurality of, possibly different memory units. Memory 110 and memory 120 may include executable code, e.g., an application, software, a program, a process, task or script. The executable code may be executed by computer 101 possibly under control of an operating system.

As illustrated in element “A”, data logger 100 may be connected to computer 101 at a departure or sender site. The connection between computer 101 and logger 100 may be any connection or communication technology which may allow data transfer between computer 101 and logger 100, for example, a USB connection, wireless USB, a Wi-Fi connection, a Bluetooth connection or any other suitable mechanism for connecting electronic devices for data transfer.

According to embodiments of the invention, while being connected to computer 101 at the shipping side, data logger 100 may be configured, e.g., by a user. The configuration may include defining of setup parameters for the logging process. Setup parameters may include, for example, sampling intervals, alarm levels, samples resolution, measurements units, e.g, temperature units (e.g., Fahrenheit scale or Celsius scale) in which the data is to be recorded and the like. The configuration may be performed by using dedicated software installed on computer 101 and stored or saved in memory 110.

According to embodiments of the invention, during configuration, parameters related to a returned notification mechanism, also referred to herein as a report or “returned report” may be received by computer 101, for example, parameters may be defined by a user. A returned notification mechanism may be used to provide to one or more contact persons an automatic report regarding for example all data recorded up to the time of sending the report. The parameters received, related to a returned notification mechanism may include information or details relating to or describing of one or more contacts, for example, a destination or address where a report should be sent (e.g. one or more e-mail addresses of the contacts to receive the returned report), contact name(s), measurement units in which the data is to be presented, a time and/or time zone (e.g., Greenwich mean time, GMT) according to which the report should be issued in order to arrive at the receiver at a certain time and the like. Other parameters related to the returned report mechanism may be defined.

The information regarding the parameters related to the returned report may be stored or saved to memory 120 of data logger 100, for example, to flash memory and may be retained as part of the logger setup. Such information may be stored or saved until deleted or changed, e.g. by a user, for example, even if the battery of the logger is removed or replaced. The configuration and setup of data logger 100 may be performed by using dedicated software installed on computer 101.

Element “B” represents a shipment travel stage which may include a transportation vehicle 103 traveling along a road or path 105 in order to arrive from the shipping side (represented in “A”) to the destination (represented in “C”). Transportation vehicle 103 may include one or more sensors 111 which may sense, detect or feel one or more parameters or data related to a content of the shipment such as temperature, light, humidity and the like. Sensors 11 may be coupled to, connected to or embedded within data logger 100 and may transfer the detected data to data logger 100. During the time of shipping, namely, while vehicle 103 may travel along path 105, data logger 100, located inside vehicle 103 and connected to sensors 111, may receive from sensors 111 a plurality of data samples related to the content of the shipment, e.g., samples of measurements sensed or detected by sensors 111 and may store, record or save in its memory 120 all or some data or information sampled and collected during the travel including time stamps of all measurements. Memory 120 in which the sensed or detected data is stored or saved may be an internal memory, an external memory device or other suitable removable and/or fixed storage unit. The data saved by memory 120 may include, for example, measurements of parameters such as temperature, light, humidity as well as the times in which the parameters were measured or sensed by sensors 111, and/or possibly other data.

Upon the arrival of vehicle 103 to the destination, or upon arrival of the shipment to the destination, represented in element “C”, data logger 100 may be connected to a destination computer 104 by any suitable connection or communication technology which may allow data transfer between computer 104 and logger 100, for example, a USB connection, a wireless USB connection, a Wi-Fi connection, a Bluetooth connection or any other mechanism for connecting electronic devices for data transfer.

Destination computer 104 may be any computing device which may include or may be, for example, a personal computer, a desktop computer, a mobile computer, a laptop computer, a notebook computer, a terminal, a workstation, a server computer, a Personal Digital Assistant (PDA) device, a tablet computer, a network device, a mobile phone, a household appliance or any other suitable computing device. Any other device or component having a processing unit may be used. According to embodiments of the present invention, computer 104 may include components such as, but not limited to, one or more CPUs 131 or any other suitable multi-purpose or specific processors or controllers, a plurality of input units, a plurality of output units, a plurality of memory units, and a plurality of storage units. Computer 104 may additionally include other suitable hardware components and/or software components

Computer 101 may include or be associated with a memory 130 which may store data operated on or created by embodiments of the present invention such as, for example, a dedicated software which when executed by a processor may cause the processor to sense or detect the connection of data logger 100.

According to embodiments of the invention, dedicated software may be installed on destination computer 104 and upon connection of data logger 100 to computer 104, the dedicated software may when executed by a processor cause the processor to detect the connection of data logger 100. In response to the connection of data logger 100 to computer 104, the data may be downloaded, and a report may be sent. The dedicated software installed on data logger 100 may enable automatic data download from the memory of data logger 100 and may enable automatic report creation or generation and report delivery to preconfigured contacts as represented by arrows 106 and 107. The preconfigured contacts may include or be defined by e-mail addresses related to one ore more parties, users or contact persons. In some embodiments, the returned report may arrive to origin computer 101 as indicated by arrow 106 while in other embodiments, the returned report may arrive a computer 150, located in any other site, position or place.

The returned report feature may be enabled by a user during data logger setup via the dedicated software installed on computer 101 at point of origin. The returned notification mechanism may be an automatic process which may start automatically upon connection of data logger 100 to destination computer 104 and may not require any user intervention. The software installed on computer 104 may include by default support of such automatic report sending or transmission so no further configuration is required on destination computer 104. According to embodiments of the invention, a default electronic e-mail account may be configured on, accessible by, or into the dedicated software on computer 104, so a user is not required to configure his e-mail account on computer 104. However, a user may choose to configure another e-mail address if necessary.

The data from data logger 100 may automatically and immediately be sent via a default e-mail account to the relevant parties, defined during setup stage, as soon as the recorded data is downloaded to memory 130 of destination computer 104 with the dedicated software installed.

The automatically downloading of the recorded data from logger 100 to destination computer 104, and the immediate report sent to the relevant personnel, may be required in order to provide a key information to the decision-makers. For example, in the event of any breach of defined thresholds, relevant action may be taken by onsite personnel in order to ensure the goods reach their markets in optimal conditions.

The returned report may be sent via an e-mail message to the predefined recipients and may include numerous predefined parameters such as data statistics, data graph, and histogram, as well as the time/date the report was issued, and the time range of the report data. The report may be generated in any suitable format, for example, a written format such as portable document format (PDF) and may indicate the logger identification such as the logger serial number and the logger name.

According to embodiments of the invention, no user intervention may be required during report generation and sending as all relevant parameter may be pre-configured and stored or saved in the memory of logger 100, e.g., a distribution list of e-mail addresses.

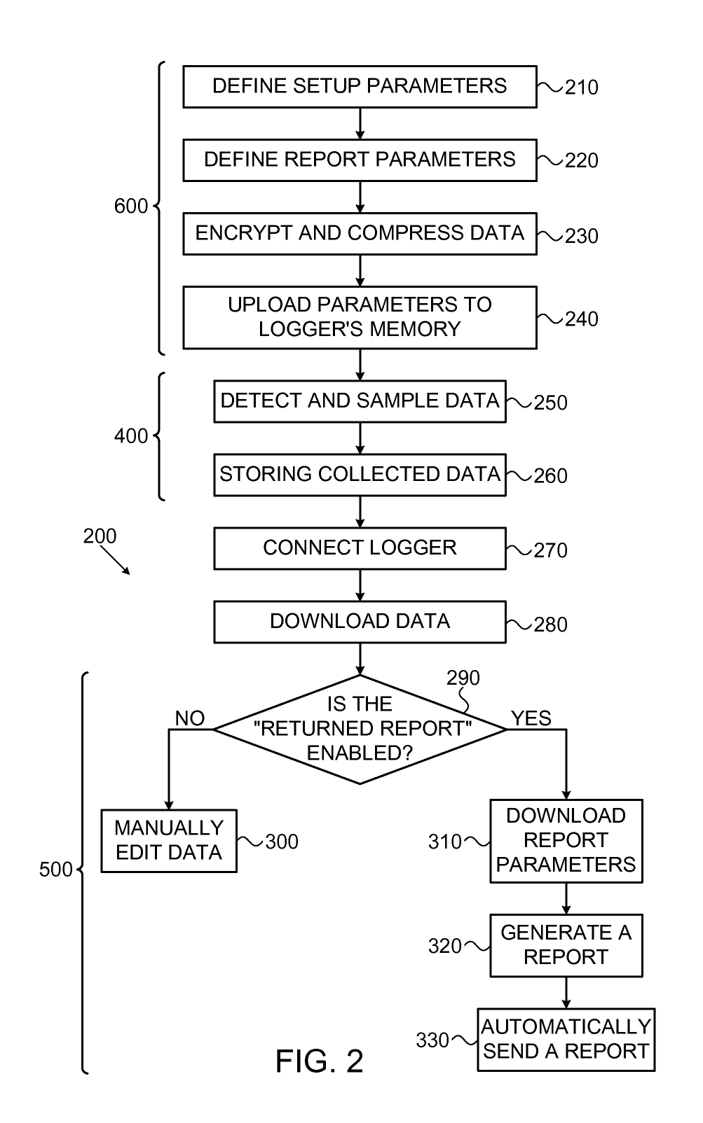

Reference is now made to FIG. 2 which is a flowchart of a method for automatic report sending according to embodiments of the present invention. Operations of the method may be implemented, for example, by one or more of the elements in FIG. 1, such as computer 101, computer 104, CPU 121, CPU 131, data logger 100 and/or by other suitable units, devices, and/or systems.

Section 600 of flowchart 200 describes the logger setup. Section 600 represents the operations of the method which may take place at the shipment departure side, e.g., represented in element A of FIG. 1. The method described in section 600 may be implemented by a computing device, e.g., computer 101 of FIG. 1.

As indicated at box 210, the method may include defining setup parameters to the data logger or accepting setup parameters by the data logger, e.g., data logger 100 of FIG. 1. A user may define a set of predefined parameters related to the data sampling and information storing of logger 100. The parameters may relate to the content of the shipment. Exemplary parameters to be defined may include the measurements type, intervals between two consecutive samples, sampling duration and the like.

As indicated at box 220, the method may include accepting parameters related to the automatic returned report. Such parameters may be defined by a user and may include the e-mail address or other address information of contact people to receive the returned report, measurements unit in which the data is to be presented, the time zone in which the report should be issued and the like. According to embodiments of the invention, one of the parameters accepted by the data logger may relate to enablement of the automatic returned report, e.g., the option of sending an automatic report to a contact person may be disabled.

As indicated at box 230, the method may optionally include encryption and compression of the logger's related parameters defined in box 210 and the returned report parameters defined in box 220. The parameters in their encrypted and compressed form may be uploaded to a memory or storage of the data logger, e.g., memory 120 of FIG. 1, as indicated at box 240. It should be understood to a person skilled in the art that the encryption and compression indicated at box 230 are optional stages and the parameters may be uploaded to the memory of the logger in any form and by any method.

Once the data is stored or saved in the memory of the data logger, the logger may be placed in or near the goods containers, to measure during shipment the temperature or other relevant parameter defined in section 600.

Section 400 of flowchart 200 represents the operations of the method during shipment transit from the departure side to the destination side, e.g., represented in element “B” of FIG. 1. As indicated at box 250, the method may include sensing or detecting and sampling of a plurality of parameters and data by one or more sensors located internally or externally to the data logger. The sampling may be performed during shipment transit and may be followed by storing of the collected data in a storage or memory of the data logger, e.g., memory 120 of FIG. 1, as indicated at box 260. The storage may be an internal storage or external storage coupled to the data logger.

Section 500 represents the operations of the method which may take place at the destination side, e.g., represented in element “C” of FIG. 1. The method described in section 500 may be implemented by a computing device, e.g., computer 104 of FIG. 1.

Although embodiments of the invention are not limited in this respect, as indicated at box 270, the method may include connecting of the data logger to a computing device such a personal computer (PC) located at the destination. Any connection or communication technology which may allow data transfer between the data logger and the computing device may be used, for example, USB connection, a wireless USB connection, a Wi-Fi connection, a Bluetooth connection or any other mechanism for connecting electronic devices for data transfer. Other embodiments of the invention may not include such a connection, for example, if the data logger includes an internal processing unit.

As indicated at box 280, the method may include downloading of the collected data stored in the memory of the data logger to the memory of the computing device. The downloading may be an automatic process after an automatic connection of the data logger to the computing device. The automatic detection of the data logger and download of the data may be performed by dedicated software installed on the computing device at the destination. Such an installation of software may be performed previous to the arrival of the shipment and may be performed only once.

As indicated by box 290, the method may include checking whether or not the received parameter indicating if automatic returned report is enabled or disabled. In case the automatic returned report is disabled, the method may include manually editing the data as indicated at box 300. In case the automatic returned report is enabled, the method may include automatic returned report procedure as indicated at boxes 310, 320 and 330.

As indicated at box 310, the method may include downloading of the parameters related to the automatic returned report, defined at box 220, from the memory of the data logger to the memory of the computing device at the destination.

As indicated at box 320, the method may include generating or creating a report according to the parameters defined at box 220. In one embodiment, the report generation and sending is automatic, in response to the connection of a data logger to a computer, or in response to the downloading of data from a logger to a computer. For example, the report may include numerous parameters such as data statistics, or data graph or histogram representing one or more parameters sensed by sensors 111 along time such as temperature, humidity and the like. The report may include the time/date the report was issued, and the time range of the report data. It should be understood that the report may be generated based on the parameters defined during setup of the logger, as indicated at box 210, or based on predefined parameters, requirements and definition defined by the software installed on the computing device at the destination. The report may be generated in any format, for example, a written PDF.

As indicated at box 330, the method may include automatic sending of the report for example in the format of or attached to an e-mail message to the e-mail addresses defined by the sender at box 220. According to embodiments of the invention. The returned data report may be sent to the defined contacts by the destination computing device, as soon as the data logger is detected by the execution of the software installed on it, and as long as a network connection (e.g., an Internet connection) is available.

In the exemplary embodiments presented by FIG. 1 and FIG. 2, the report is generated at the destination, however, it should be understood to a person skilled in the art that the automatic report may be generated and sent to the predefined contacts at any stage during the shipment when the logger is connected to a computer. In such an embodiment the report may include all data recorded up to that stage. Other embodiments may include a logger equipped with or coupled to a computing device which may allow a report generation and sending at any time during the shipment.

It should be understood to a person skilled in the art that other operations or sets of operations may be used in accordance with embodiments of the invention.

Although the scope of the invention is not limited in this regard, a computing device described in embodiments of the invention, e.g., computer 101 and/or computer 104 may include an operating system which may be or may include any code segment designed and/or configured to perform tasks involving coordination, scheduling, arbitration, supervising, controlling or otherwise managing operation of the computing device. Such an operating system may be a commercial operating system. The computing device disclosed herein may include a memory which may be or may include, for example, a RAM, a ROM, a DRAM, a SD-RAM, a DDR memory chip, a Flash memory, a volatile memory, a non-volatile memory, a cache memory, a buffer, a short term memory unit, a long term memory unit, or other suitable memory units or storage units. The memory may be or may include a plurality of, possibly different memory units. The software described herein may include executable code, e.g., an application, a program, a process, task or script and may possibly be under control of the operating system.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for automatic report sending, the method comprising:
storing parameters related to a report in a memory of a data logger;
collecting during shipment transit, data related to a content of the shipment;
upon arrival of the shipment to a destination, generating a report based on the parameters; and
automatically sending the report to a contact person.

2. The method of claim 2, wherein the parameters include details of the contact person.

3. The method of claim 1, wherein the parameters include parameters related to a collection of data.

4. The method of claim 3, wherein details of the contact person comprise an e-mail address of the contact person.

5. The method of claim 1, wherein the data logger is connected to a sensor.

6. The method of claim 6, wherein collecting the data comprises detecting the data by the sensor and transferring the data to the data logger.

7. The method of claim 1, wherein generating the report comprises downloading the parameters and the data related to the content of the shipment to a computer.

8. A system for automatic report sending, the system comprising:
a memory; and
a processor to:
receive from a data logger data collected by a sensor during shipment transit, the data related to a content of the shipment, the data logger to store parameters and to receive the data from the sensor; and
generate a report based on the parameters upon arrival of the shipment to a destination and to automatically send the report to a contact person.

9. The system of claim 8, wherein the processor is to accept the parameters related to the report by the data logger.

10. The system of claim 8, wherein the parameters include details of the contact person.

11. The system of claim 8, wherein the parameters include parameters related to a collection of data.

12. The system of claim 10, wherein the details of the contact person comprise an e-mail address of the contact person.

13. The system of claim 9, wherein the data logger is to download the parameters and the data related to the content of the shipment to the computer.

14. A method for transmitting a report, the method comprising:
in response to the connection of a data logger to a computer:
accepting data sensed by a sensor, the sensor sensing data from a shipment of goods;
creating a report based on the data; and
sending the report to a contact.

15. The method of claim 14, further comprising:
accepting, by the computer, parameters related to the report.

16. The method of claim 14, wherein the parameters include details of the contact.

17. The method of claim 16, wherein the details of the contact comprise an e-mail address of the contact.

18. The method of claim 14, wherein the data logger is connected to the sensor.
